(19) United States
(12) Patent Application Publication
(10) Pub. No.: US 2020/0208807 A1
(43) Pub. Date: Jul. 2, 2020

(54) Specialty Punt Illumining Light Tool

(71) Applicant: Michael Hintz, Oakdale, CT (US)

(72) Inventor: Michael Hintz, Oakdale, CT (US)

(21) Appl. No.: 16/237,706

(22) Filed: Jan. 1, 2019

(51) Int. Cl. F21V 9/30

(52) U.S. Cl. CPC F21V 9/30; F21W 2131/30

(57) ABSTRACT

Brief Summary: This invention is intended to illuminate the vessel from below for cosmetic or aesthetic purposes. Ideally the machine is built to fit self contained within the void in the bottom of the vessel for practical purposes but can be adapted with a base collar to contain the apparatus and attach to the vessel.

### FIELD

This relates to an invention that will illumine a specific vessel with a punt using the device or tool.

### BACKGROUND

This is a new application for a new patent with no prior application background.

Appendix referring to prior art. Please see patents: U.S. Pat. Nos. 10,156,326; 6,095,661; 7,147,343; 7,972,030; 7,224,000; 7,980,747; 4,719,159; 5,154,989; 9,911,870; 3,655,452

### SUMMARY

The Specialty Punt Illumining Light Tool (SPILT) is constructed in a way that allows the device to shine from the bottom of a vessel thus illumining the liquid above. It is fitted to the bottom of the vessel and when turned on will make the liquid in the vessel appear to glow.

[symbol]

### BRIEF DESCRIPTION OF DRAWINGS

Several drawing are here presented to describe the invention. Since the vessel is not part of the invention, fitment and dimensions are not completely detailed. For a matter of reference, the void described is likely one half to three quarters of an inch at the apex so the device is no thicker or taller than the vessel void. An alternate arrangement can be constructed with a suitable collar to hold said machine.

FIG. 1A shows a clear glass bottle like a wine glass that has a punt or void in the bottom and is neither frosted or opaque; FIG. 1B: is a clear glass again containing a bottom punt or concave void at the bottom; FIG. 1C: is a clear glass similar to a champagne glass or wine flute which also must have a void in the bottom. The device is designed to fit into or within said void as described.

FIG. 2 shows the invention in its entirety but not to scale.

FIG. 3 shows the breakdown components in an exploded view.

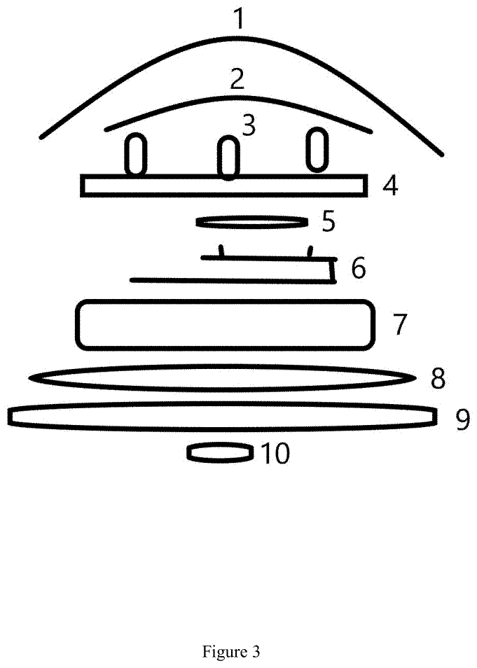

FIG. 4 A shows a partial side view while FIG. 4 B shows a partial bottom view.

### DETAILED DESCRIPTION

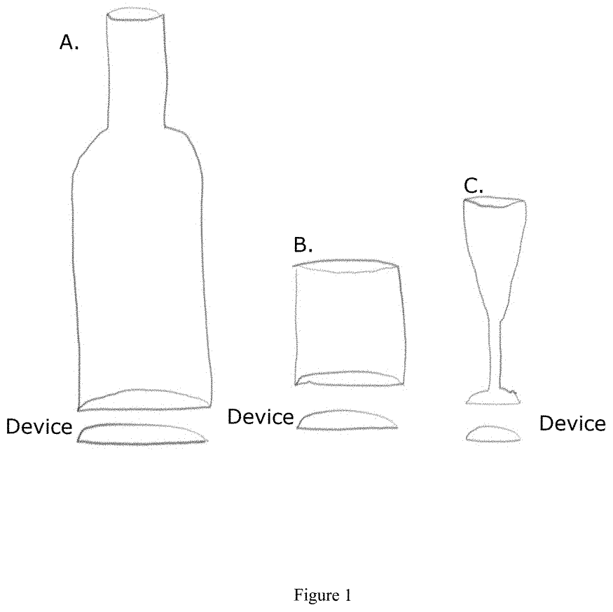

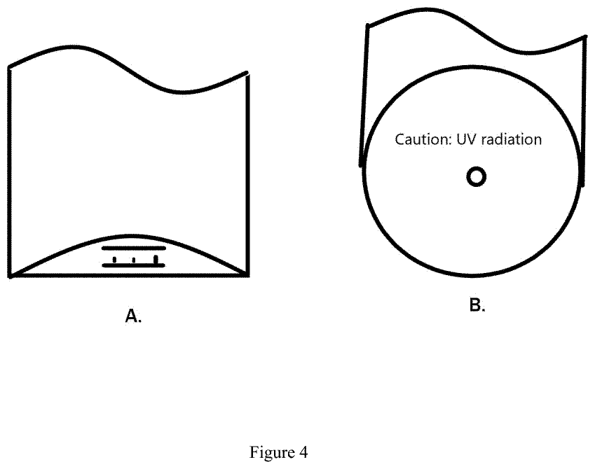

Specifically FIG. 1A is a clear wine bottle with a manufactured punt. The bottle should not be frosted or opaque to maximize the luminosity of the liquid that will be contained within. FIG. 1B is a clear drinking glass with a bottom void or punt similar in design to the wine bottle facilitating the insertion of the invention. FIG. 1C is a clear wine glass or champagne flute manufactured with a bottom void or punt where the invention can be contained. The purpose of this setup will be explained in the claims section. For clarity ‘Device’ refers to the invention being claimed. FIG. 4A is the device shown in place on the bottom of a vessel, from a side view perspective and then FIG. 4B a bottom view perspective.

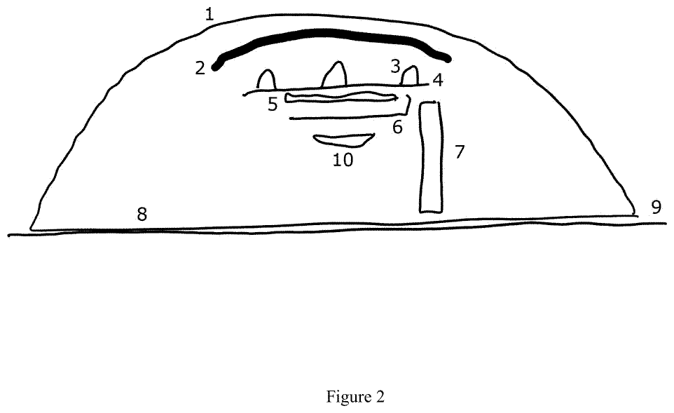

FIG. 2 and its parts shall be described in this section. Since figure two and figure three are equivalent in their numbering, only one description is necessary for both. 1 is a diffusion layer that will be closest to the glass. Shining a light directly as with a LED light will result in collimated beam which is less desirable. The diffusion material will act to disperse the light beam from the LED or LED array so the entire contents of the glass vessel will be illuminated. 2 is an ultraviolet filter which will allow only ultraviolet wavelength light to pass beyond this filter. This filter is placed in front of the LED light bulb or bulbs and is essential to the invention because of the concerted action of the light with the specialized liquid contained in the glass vessel to be explained in the claim. 3 is a light-emitting diode (LED) or LED array as per the spacial arrangement and volume of the cylinder; read, a wine glass may require as few as one LED while a wine bottle may require up to a half dozen or dozen LEDs for the required illumination of the liquid contained. 4 is a solid support or circuit board to contain the LEDs. The use of a circuit board affords variation in the utility of the device. For instance, the LED array on the circuit board will allow for timing or simplifying the addition of an on/off switch installation. 5 is the battery power supply or multiple batteries used for power. 6 is the holder for the battery or batteries that will be attached to the solid support. 7 is a spacer. Depending on the geometry of the punt, a spacer or support of different size may be needed to hold together the components of the invention. 8 is a reflective material or foil such that stray light will be reflected or deflected back up towards the UV (ultraviolet) filter and through it and the diffuser towards the liquid. 9 is adhesive material on a backer that will hold the [page 0005 application Ser. No. 16/237,706] invention fast to whichever vessel is used. This material can range from the width of the vessel to slightly larger than the vessel width in order to facilitate the fitment of the device, such that this piece might constitute a base piece attached firmly to the glass. 10 is an on/off switch to be contained on the device such that the device light will be on only when in use. This makes the device recyclable such that it can be removed from the vessel and reused instead of being discarded. This completes the description of the invention but does not completely clarify the claim of the device.

Figure three, see above. Figure three is the exploded view of figure two and is functionally equivalent.

FIG. 4A is the device shown in place on the bottom of a vessel, from a side view perspective and then FIG. 4B a bottom view perspective.

1. (canceled)

2. (canceled)

3. (canceled)

4. An illumining device comprising: the components listed in the drawings section that will use specially filtered light where the new invention or device will be placed and affixed to the bottom of or below a vessel, described as having a hollow or ‘punt’ that the said invention is placed within and fits into where it will be attached to shine filtered light through the listed example vessel(s) in the drawings, of glass or other material, such that the filtered light will interact with the composition of the liquid or chemical(s) in the liquid to produce a glow or fluorescing or phosphorescing of the GRAS, or generally recognized as safe, food grade chemical in the liquid which may be intended to contain alcohol for consumption and will therefore be illuminated by this process in this described manner; (the invention should not be limited except for the above mentioned claim and their equivalents, the illustrations described will explain how the device can and will function).
